(19) United States
(12) Patent Application Publication
(10) Pub. No.: US 2019/0287400 A1
(43) Pub. Date: Sep. 19, 2019

(54) METHOD, DEVICE AND SYSTEM FOR PARKING SPACE NAVIGATION

(71) Applicant: BOE TECHNOLOGY GROUP CO., LTD., Beijing (CN)

(72) Inventors: Shijie CAO, Beijing (CN); Yifei ZHANG, Beijing (CN); Wei DENG, Beijing (CN)

(21) Appl. No.: 16/122,683

(22) Filed: Sep. 5, 2018

(30) Foreign Application Priority Data
Mar. 13, 2018 (CN) 201810205409.5

(51) Int. Cl. G08G 1/14; G08G 1/017

(52) U.S. Cl. CPC G08G 1/142; G08G 1/0175

(57) ABSTRACT

At least one embodiment of the present disclosure disclose a method, a device, and a system for parking space navigation. The method for parking space navigation includes: acquiring, by a processor, an entry position and identity information of a vehicle; determining, by the processor, a target parking space and planning a parking route for the vehicle according to current available parking space information of a parking lot and the entry position of the vehicle; and based on the identity information of the vehicle and the parking route, controlling, by the processor, a directing apparatus in the parking lot to guide the vehicle to enter the target parking space.

### CROSS-REFERENCE TO RELATED APPLICATION(S)

This application claims priority to Chinese Application No. 201810205409.5, entitled “METHOD AND SYSTEM FOR PARKING SPACE NAVIGATION” and filed on Mar. 13, 2018, which is incorporated herein by reference in its entirety.

### TECHNICAL FIELD

The present disclosure relates, but not limited to the field of communication technology, and in particular to a vehicle navigation method, a vehicle navigation device and a vehicle navigation system.

### BACKGROUND

With development of automobile technology and popularization of vehicles, use of vehicles in daily life has been greatly improved, and underground and aboveground garages in various places have also been increased.

In actual application scenarios of a parking lot, due to factors such as a size, route and complexity of the parking lot, the driver often takes a long time to find a parking space during a parking process. In a case of fewer parking spaces, the driver may miss a parking space due to an unclear goal. The current vehicle navigation or mobile navigation application (abbr. “APP”) is usually designed for public roads, and is difficult to achieve accurate positioning in the parking lot, and cannot find the parking space by navigation in a parking lot with a poor network signal. In addition, staffs are hired to direct the driver to enter the parking space in some parking lots, and such a parking method is inefficient, costly, and has certain safety hazards.

### SUMMARY

According to an aspect of the present disclosure, the present disclosure provides a parking space navigation method. The parking space navigation method includes: acquiring, by a processor, an entry position and identity information of a vehicle; determining, by the processor, a target parking space for the vehicle according to current vacancy information of a parking lot and the entry position of the vehicle, and planning a parking route; and according to the identity information of the vehicle and the parking route, controlling, by the processor, a directing apparatus in the parking lot to direct the vehicle to enter the target parking space.

In some embodiments, the directing apparatus is an indicator light.

In some embodiments, the parking space navigation method further includes: identifying, by the processor, the identity information of the vehicle according to a received image of the vehicle in the parking lot which is captured in real time; the controlling the directing apparatus in the parking lot to direct the vehicle to enter the target parking space includes: matching, by the processor, currently identified identity information with recorded identity information to extract a parking route corresponding to the currently identified identity information; and controlling, by the processor, the directing apparatus in the parking lot to direct the vehicle to enter the target parking space according to the extracted parking route.

In some embodiments, the controlling, by the processor, the directing apparatus in the parking lot to direct the vehicle to enter the target parking space includes: controlling, by the processor, the directing apparatus in the parking lot to direct the vehicle with a driving direction at each intersection where the vehicle passes, until the vehicle is directed to enter the target parking space.

In some embodiments, in a case that a plurality of vehicles enter the parking lot, and the plurality of vehicles are located in different arms of an intersection, the controlling, by the processor, the directing apparatus in the parking lot to direct the vehicle with the driving direction at each intersection where the vehicle passes includes: controlling, by the processor, the directing apparatus at the intersection to direct the vehicles with the respective driving directions sequentially according to priorities of the plurality of vehicles; or controlling, by the processor, the directing apparatus at the intersection to direct the vehicles with the respective driving directions simultaneously.

In some embodiments, the parking space navigation method further includes: acquiring, by the processor, the vacancy information of the parking lot in real time.

In some embodiments, the acquiring, by the processor, the vacancy information of the parking lot in real time includes: acquiring, by the processor, the vacancy information of the parking lot according to a received image of each parking space in the parking lot which is captured in real time; or acquiring, by the processor, the vacancy information of the parking lot according to a current state of each parking space which is monitored in real time by and received from a sensing apparatus in each parking space in the parking lot.

In some embodiments, the parking space navigation method further includes: adjusting, by the processor, the target parking space of the vehicle and re-planning the parking route of the vehicle according to the vacancy information acquired in real time.

According to another aspect of the present disclosure, the present disclosure provides a parking space navigation device. The parking space navigation device includes: a processor; a memory storing instructions that, when executed by the processor, cause the processor to: acquire an entry position and identity information of a vehicle; determine a target parking space for the vehicle according to current vacancy information of a parking lot and the entry position of the vehicle, and plan a parking route; and control a directing apparatus in the parking lot to direct the vehicle to enter the target parking space, according to the identity information of the vehicle and the parking route.

In some embodiments, the directing apparatus is an indicator light.

In some embodiments, the instructions that, when executed by the processor, further cause the processor to: identify the identity information of the vehicle according to a received image of the vehicle in the parking lot which is captured in real time; match currently identified identity information with recorded identity information to extract a parking route corresponding to the currently identified identity information; and control the directing apparatus in the parking lot to direct the vehicle to enter the target parking space according to the extracted parking route.

In some embodiments, the instructions that, when executed by the processor, further cause the processor to: control the directing apparatus in the parking lot to direct the vehicle with a driving direction at each intersection where the vehicle passes, until the vehicle is directed to enter the target parking space.

In some embodiments, the instructions that, when executed by the processor, further cause the processor to, in a case that a plurality of vehicles enter the parking lot, and the plurality of vehicles are located in different arms of an intersection, control the directing apparatus at the intersection to direct the vehicles with the respective driving directions sequentially according to priorities of the plurality of vehicles; or control the directing apparatus at the intersection to direct the vehicles with the respective driving directions simultaneously.

In some embodiments, the instructions that, when executed by the processor, further cause the processor to acquire the vacancy information of the parking lot in real time.

In some embodiments, the instructions that, when executed by the processor, further cause the processor to acquire the vacancy information of the parking lot according to a received image of each parking space in the parking lot which is captured in real time; or acquire the vacancy information of the parking lot according to a current status of each parking space which is monitored in real time by and received from a sensing apparatus in each parking space in the parking lot.

In some embodiments, the instructions that, when executed by the processor, further cause the processor to adjust, by the processor, the target parking space of the vehicle and re-plan the parking route of the vehicle according to the vacancy information acquired in real time. In some embodiments, indicators of the directing apparatus comprises: Turn Left, Turn Right, Go Forward, U-Turn, Halt, and Parking Here.

In some embodiments, the indicator light is operated in one or more of following modes: a mode where different colors displayed by the indicator light indicate different driving states of the vehicle; a mode where different colors displayed by the indicator light indicate different driving directions of the vehicle; and a mode where different symbols displayed by the indicator light indicate different driving directions of the vehicle.

According to yet another aspect of the present disclosure, the present disclosure provides a non-transitory computer readable storage medium having stored thereon instructions that, when executed by one or more processors, cause the one or more processors to perform the previous methods.

According to yet another aspect of the present disclosure, the present disclosure provides a parking space navigation system, including: the previously described parking space navigation device; one or more cameras, communicatively coupled to the parking space navigation device, and configured to capture an image of an entered vehicle and/or an image of a parking space in a parking lot, and transmit the captured image to the parking space navigation device; and one or more directing apparatuses, communicatively coupled to the parking space navigation device, and configured to display an indication for directing the vehicle under control of the parking space navigation device.

### BRIEF DESCRIPTION OF THE DRAWINGS

The drawings are used to provide a further understanding of the technical solutions of the present disclosure, and constitute a part of the specification. The drawings are used to explain the technical solutions of the present disclosure, in conjunction with at least one embodiments of the present disclosure, and do not constitute any limitation of the technical solutions of the present disclosure.

FIG. 1 is an exemplary flowchart of a parking space navigation method according to at least one embodiment of the present disclosure;

FIG. 2 is an exemplary schematic diagram of parking spaces in a parking lot in a parking space navigation method according to at least one embodiment of the present disclosure;

FIG. 3 is an exemplary flowchart of another parking space navigation method according to at least one embodiment of the present disclosure;

FIG. 4 is a schematic diagram of an exemplary application scenario of a parking lot in a parking space navigation method according to at least one embodiment of the present disclosure;

FIG. 5 is a schematic diagram of another exemplary application scenario of a parking lot in a parking space navigation method according to at least one embodiment of the present disclosure;

FIG. 6 is a schematic diagram of yet another exemplary application scenario of a parking lot in a parking space navigation method according to at least one embodiment of the present disclosure;

FIG. 7 is an exemplary flowchart of yet another parking space navigation method according to at least one embodiment of the present disclosure;

FIG. 8 is an exemplary schematic structure diagram of a parking space navigation system according to at least one embodiment of the present disclosure; and

FIG. 9 is an exemplary schematic structure diagram of another parking space navigation system according to at least one embodiment of the present disclosure.

### DETAILED DESCRIPTION

In order to make the objects, technical solutions and advantages of the present disclosure more clear, at least one embodiments of the present disclosure will be described in detail below with reference to the accompanying drawings. It should be noted that at least one embodiments and features in at least one embodiments in the present disclosure may be arbitrarily combined with each other in a case of no conflict.

The following particular embodiments provided by the present disclosure may be combined with each other, and the same or similar concepts or processes may not be repeatedly described in some embodiments for simplicity.

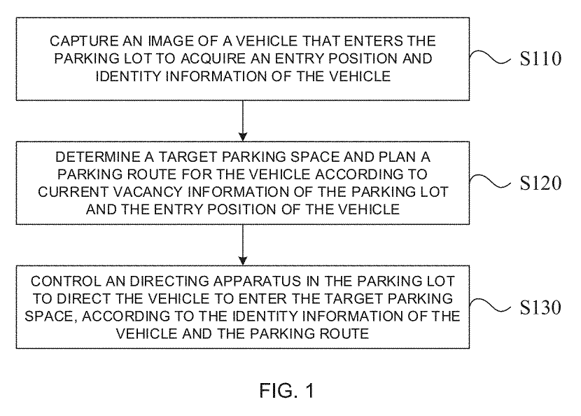

FIG. 1 is an exemplary flowchart of a parking space navigation method according to at least one embodiment of the present disclosure. The parking space navigation method provided by at least one embodiment of the present disclosure may include steps as follows.

In step S110, an image of a vehicle that enters the parking lot is captured to acquire an entry position and identity information of the vehicle.

The parking space navigation method provided by at least one embodiment of the present disclosure is a method of directing a parking space for the vehicle entered in the parking lot. In at least one embodiment of the present disclosure, each entrance in the parking lot may be provided with a camera, and each camera is used for capturing an image of a vehicle entering from the current entrance to the parking lot, and collecting related information, e.g. including the entry position and the identity information, of the vehicle. When a parking route is planned for the vehicle, the entry position of the vehicle may be taken into consideration, so as to find an optimal parking space for the vehicle, e.g. a parking space that makes the vehicle travel the shortest distance, or a parking space closest to the destination address of the vehicle; and the identity information is used to identify the vehicle when the vehicle is subsequently navigated for parking.

It should be noted that the identity information of the vehicle in at least one embodiments of the present disclosure is information for identifying the vehicle, which may be license plate information of the vehicle, and may also be an electronic license plate or an electronic tag of the vehicle; for example, when some vehicle enters the parking lot, the electronic apparatus at the entrance configures the vehicle with an electronic tag for quickly and accurately identifying the vehicle during subsequent navigation.

In step S120, according to current vacancy information of the parking lot and the entry position of the vehicle, a target parking space is determined for the vehicle and a parking route is planned.

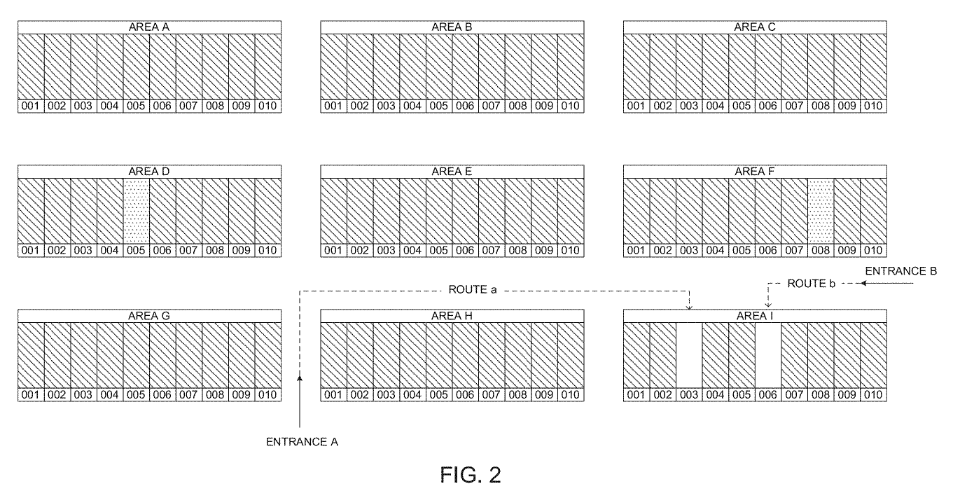

In at least one embodiment of the present disclosure, when the route to a parking space is being planned for some vehicle, it is first necessary to know which of the current parking spaces in the parking lot are available, and the current vacancy information in the parking lot may be known from the system for performing the parking space navigation. FIG. 2 is an exemplary schematic diagram of parking spaces in the parking lot in the parking space navigation method according to at least one embodiment of the present disclosure. A˜I in FIG. 2 represent 9 areas of the parking lot, and there are 10 parking spaces in each area, whose numbers are 001˜010. As shown in FIG. 2, the parking spaces in the 8 areas A˜H in the parking lot are all occupied, and only the parking spaces 003 and 006 in Area I are vacant. Thus, the acquired vacancy information is 003 and 006 in Area I. It should be noted that the current vacancy information identified by the system includes not only the currently vacant parking spaces in the parking lot, but also the parking spaces that have been planned for other vehicles although not being occupied by any vehicle. As shown in FIG. 2, 005 in Area D and 008 in Area F are vacant currently, but they have been used as the target parking spaces for other vehicles, and are in a to-be-entered state.

For example, the entrances of the parking lot are Entrance A and Entrance B, as shown in FIG. 2. A parking space closest or most convenient to the vehicle, i.e., the target parking space, may be obtained by analyzing based on the known vacancy information in conjunction with the entry position (Entrance A or Entrance B) when the vehicle enters the parking lot. Then, a parking route may be planned for the vehicle for navigation according to the obtained target parking space and the entry position of the vehicle. In the actual parking scenario, if the entry position of the vehicle is Entrance A, 003 of Area I may be used as the target parking space, the parking route is Route a in FIG. 2; and if the entry position of the vehicle is Entrance B, 006 of Area I may be used as the target parking space, and the parking route is Route b in FIG. 2.

It should be noted that the entrances, the parking spaces, the vacancy information, the target parking space and the parking route of the parking lot as shown in FIG. 2 are only illustrative description of at least one embodiments of the present disclosure, and the implementations of the parking space navigation method provided by at least one embodiments of the present disclosure are not limited thereto. The implementations of at least one embodiments of the present disclosure may be related to the actual parking spaces and/or road planning in the parking lot.

In step S130, a directing apparatus in the parking lot is controlled to direct the vehicle to enter the target parking space, according to the identity information of the vehicle and the parking route.

The parking lot of at least one embodiment of the present disclosure is provided with the directing apparatus, and the parking space navigation system may control the directing apparatus in the parking lot to guide a driving route and direction for some vehicle according to the parking route that has been planned for the specified vehicle, until the vehicle is directed to enter the target parking space. In an actual process of directing the parking, since the vehicle is a dynamic object, its position in the parking lot is also dynamically changed according to its driving route. Therefore, in the process of directing the vehicle to enter the target parking space, the vehicle may be directed in combination with the identity information of the vehicle. The identity information of the vehicle is unique information of the vehicle as the vehicle identification when the vehicle enters the entrance of the parking lot. By identifying and distinguishing the vehicle by the identity information, it is ensured that each vehicle is directed to the corresponding target parking space according to the parking route planned for the vehicle.

In addition, it should be noted that the directing apparatus used in the above embodiments is an indicator light. However, the present disclosure is not limited thereto. In other embodiments, the directing apparatus may be, for example, a speaker, a display screen, an electronic map, and the like.

It should be noted that the parking space navigation method in at least one embodiments of the present disclosure does not need to hire a staff to clear and guide the traffic conditions in the parking lot, thereby saving labor costs and avoiding safety hazards caused by human operations. Additionally, there is no need to use any vehicle navigation and mobile navigation APPs, so that the parking guidance in the parking lot does not need to rely on the Global Positioning System (GPS), which thus avoids navigation failure due to the poor network signal. When the parking space navigation method in at least one embodiments of the present disclosure is used for navigating the vehicle entering the parking lot to park, only various facilities configured within the parking lot are relayed on for directing and navigation, the driver may be indicated to accurately enter the planned parking space, and it may also avoid unnecessary disputes caused by multiple drivers in order to compete for one parking space.

In the parking space navigation method provided by at least one embodiment of the present disclosure, based on the current known vacancy information in the parking lot, the optimal parking space (i.e., the target parking space) may be determined for the vehicle entering the parking lot, and the parking route may be planned for it, and the vehicle may be directed to enter the target parking space based on the acquired identity information, wherein the directing manner may be accurately directed by the indicator light in the parking lot. The parking space navigation method provided by at least one embodiment of the present disclosure may indicate the driver to enter the planned parking space accurately dependent only on various facilities configured within the parking lot. That is, the parking space navigation method provided by at least one embodiment of the present disclosure realizes an intelligent navigation in the parking lot without relying on the network navigation and the human guidance, thereby solving the problem that the driver has difficulty in finding the route to the parking space in the parking lot, and enabling efficient and fast parking.

Further, the system may know not only the parking spaces that are currently vacant, but also the parking spaces that have been planned for other vehicles that are not in the parking lot but have not been occupied yet. Therefore, when planning the target parking space for the newly entered vehicle, both the actual occupied parking spaces and the potentially occupied parking spaces may be excluded, thereby avoiding unnecessary disputes caused by multiple drivers in order to compete for one parking space.

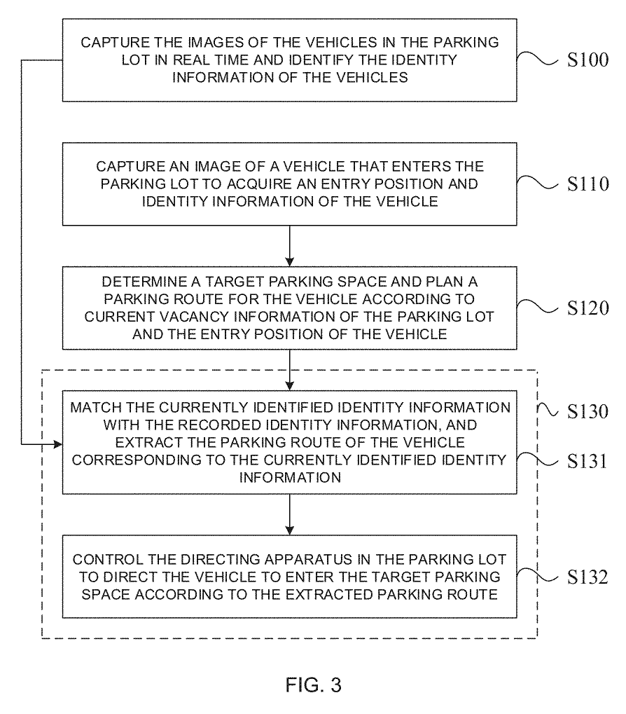

Optionally, FIG. 3 is an exemplary flowchart of another parking space navigation method according to at least one embodiment of the present disclosure. Based on at least one embodiment as shown in FIG. 1, the method provided by the present embodiments of the present disclosure may further include steps as follows.

In step S100, images of the vehicles in the parking lot are captured in real time and the identity information of the vehicles are identified.

In the parking lot of at least one embodiment of the present disclosure, a plurality of cameras may be arranged for capturing the images of the vehicles in the parking lot in real time, that is, when the vehicle is traveling at different positions in the parking lot, its images may be captured by the camera closer to the vehicle, and the identity information of the vehicle may be identified. The identity information identified at this time is consistent with the identity information of the vehicle when entering the parking lot.

It should be noted that at least one embodiment of the present disclosure does not limit the execution order of S100 and S110˜S130. S100 is continuously executed, for example, may be performed according to a certain time period, or may be performed when the camera detects a change of its surrounding vehicles.

Implementations of step S130 in at least one embodiment of the present disclosure may include:

step S131 of matching the currently identified identity information with the recorded identity information, and extracting the parking route of the vehicle corresponding to the currently identified identity information; and

step S132 of controlling the indicator light in the parking lot to direct the vehicle to enter the target parking space according to the extracted parking route.

In at least one embodiment of the present disclosure, when some vehicle travels to any position in the parking lot, the camera in a range of the position may capture and identify the identity information of the vehicle as a basis for directing the vehicle to enter the parking space accurately. Each time the identity information of the vehicle is identified, the identity information is compared with the identity information recorded in the system, and the parking route that has been planned for the vehicle is extracted, then the indicator light is controlled according to the parking route to navigate the parking of the vehicle.

Optionally, in at least one embodiment of the present disclosure, the implementation of controlling the indicator light in the parking lot to direct the vehicle to enter the target parking space may include: controlling the indicator light in the parking lot to indicate the vehicle at each intersection where the vehicle passes, until the vehicle is directed to enter the target parking space.

In practical applications, since the parking space navigation system indicates the driving route and direction by only the indicator light without the network navigation, based on the actual environment and route conditions in the parking lot, if the vehicle travels in a straight line, and does not encounter an intersection during travelling, it does not need to change the direction, and thus no special guidance is needed at this time. When the vehicle encounters an intersection or other crossings, the direction to which the vehicle is driven is closely related to whether a parking space can be accurately found for the vehicle. Therefore, the vehicle may be specially indicated at each intersection where the vehicle passes, e.g., Turn Left, Turn right, or Go Forward. The vehicle may be directed to the target parking space by the guidance of the indicator lights at one or more intersections.

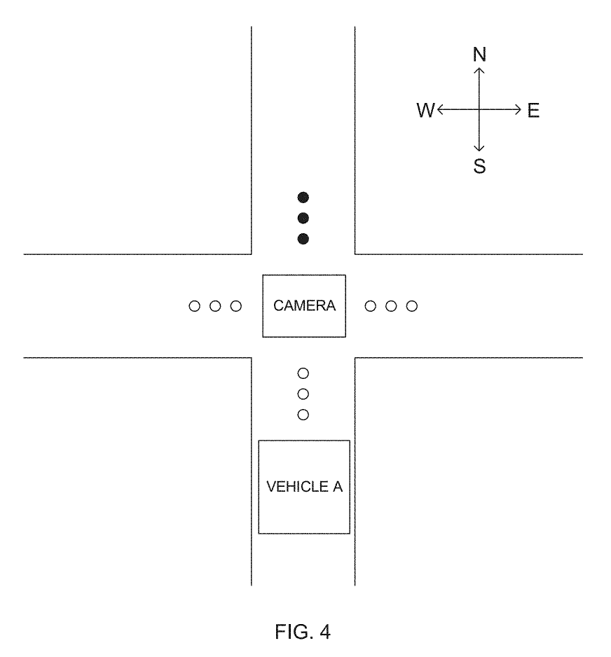

For example, FIG. 4 is a schematic diagram of an exemplary application scenario of a parking lot in a parking space navigation method according to at least one embodiment of the present disclosure. FIG. 4 shows an intersection in the parking lot. The camera identifies that Vehicle A is coming from South to North, that is, at the south of the intersection. At this time, Vehicle A has three driving directions: Forward, Left, and Right. After the identity information of the vehicle is identified, the driving direction is determined according to the parking route planned for Vehicle A. If the route of Vehicle A is straight northward, the indicator lights at north are turned ON (black circles in FIG. 4 represent ON), and the remaining three columns of indicator lights are OFF (white circles in FIG. 4 represent OFF). After Vehicle A passes the intersection, this column of indicator lights are turned OFF, preparing for the vehicles coming subsequently.

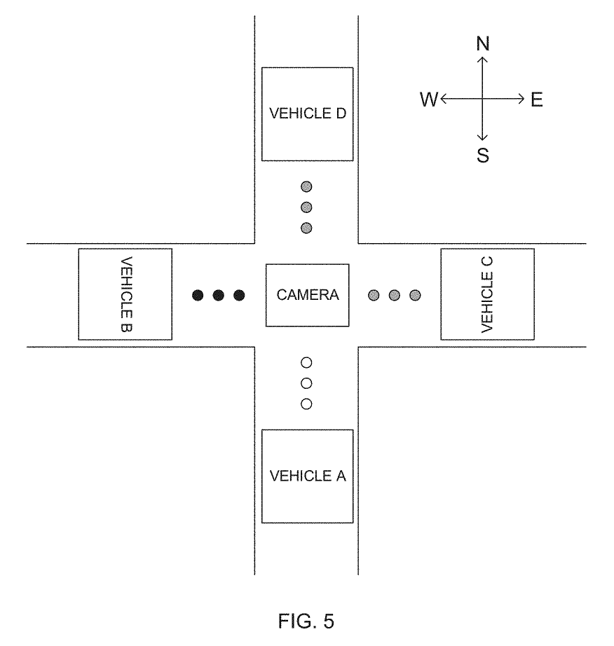

In practical scenarios, there are usually more than one vehicle looking for the parking space in the parking lot, and there may be a plurality of vehicles at each intersection that need the guidance of the parking route. The plurality of vehicles may be located in different arms of one intersection. Each of the vehicles at different geographical locations may be directed by the indicator light in the vicinity of the vehicle. The driving direction of each of the plurality of vehicles located in different arms of one intersection is required to be directed separately, as shown in FIG. 5. FIG. 5 is a schematic diagram of another exemplary application scenario of a parking lot in a parking space navigation method according to at least one embodiment of the present disclosure. FIG. 5 also shows an intersection in the parking lot, in which Vehicle A comes from South of the intersection, Vehicle B comes from West of the intersection, Vehicle D comes from North of the intersection, and Vehicle C comes from East of the intersection. In this case, the implementation of controlling the indicator lights in the parking lot to direct the vehicle to enter the target parking space in at least one embodiment of the present disclosure may include approaches as follows.

First Approach—

Controlling the indicator lights at the intersection to direct the plurality of vehicles with the respective driving directions sequentially according to priorities of the respective vehicles.

In at least one embodiment of the present disclosure, the priorities of the plurality of vehicles may be the order in which the vehicles enter the parking lot by default. If there is a special type of vehicle in the plurality of vehicles, such as an ambulance or a police car, this vehicle has the highest priority. Referring to the scenario as shown in FIG. 5, the indicator lights at the intersection are, for example, Light Emitting Diode (LED) lamps arranged on the road surface. When the LED light is lit green, it directs the driving direction of the vehicle. The order in which the vehicles are sequentially indicated is set as Vehicles A, B, C and D (or in other orders). If it is determined according to the parking route of Vehicle A that Vehicle A should turn left at this time, the LED lights on the ground may indicate as follows.

For Vehicle A: the column of LED lights in front of it are in the OFF state (the white circles in FIG. 5) —when the LED lights in front of a vehicle is in the OFF state, the vehicle may pass by default; and the LED lights on the left turn road are lit green (the black circles in FIG. 5). Thus, it may be determined that Vehicle A should turn left at this time.

For Vehicle B: the column of LED lights in front of it are in the ON state (lit green, the black circles in FIG. 5) —when the LED lights in front of a vehicle are in the ON state, the vehicle is forbidden to pass by default. Thus, Vehicle B waits for a while.

For Vehicle C: the column of LED lights in front of it are in the ON state (lit red, the gray circles in FIG. 5) —when the LED lights in front of a vehicle are in the ON state, the vehicle is forbidden to pass by default. Thus, Vehicle C waits for a while.

For Vehicle D: Similar to Vehicle C.

When Vehicle A passes the intersection, the driving directions of Vehicles B, C, and D are directed sequentially according to the order. The directing manner is similar to the manner of directing the vehicle A, and description thereof is thus omitted here for simplicity. According to the above approach of directing the vehicles to pass through the intersection sequentially, the waiting time is shorter, which may ensure that the vehicles drive to the target parking spaces accurately while passing through the intersection in an orderly manner.

Second Approach—

Controlling the indicator lights at the intersection to direct each of the vehicles with their respective driving direction simultaneously.

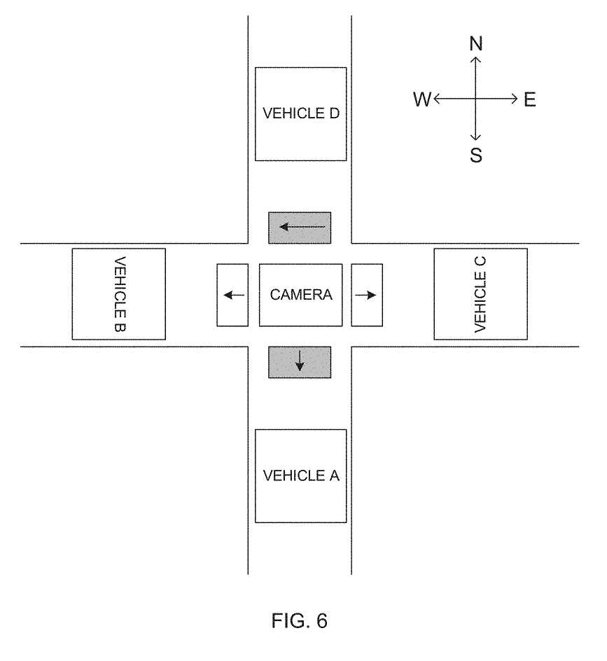

In at least one embodiment of the present disclosure, the indicator light may be arranged not only on the ground of the road in the parking lot, but also on top of each arm of the intersection or the center of the intersection, similar to the traffic indicator light, as shown in FIG. 6. FIG. 6 is a schematic diagram of yet another exemplary application scenario of a parking lot in a parking space navigation method according to at least one embodiment of the present disclosure. The indicator light in FIG. 6 may also be the LED light, which is arranged on top of each arm, and used for indicating the driving direction of its opposite vehicle. For example, if it is determined according to the parking route of Vehicle A that Vehicle A should turn left at this time, the LED light opposite to Vehicle A is lit green and displays a Turn-Left arrow. At this time, Vehicle A and Vehicle D may communicate with each other, and determine that Vehicle B and Vehicle C should go forward, then the LED lights opposite to Vehicle B and Vehicle C are lit red and display Go-Forward arrows. Here, Vehicle B and Vehicle C wait for a while, and communicate when the corresponding LED lights are lit green. In FIG. 6, the LED light lit green is indicated by a gray box, and lit red is indicated by a white box.

For various application scenarios as illustrated in the above embodiments of the present disclosure, indicators that may be shown by the indicator light include, for example, Turn Left, Turn Right, Go Forward and/or Halt etc., and may also include U-Turn, and/or Parking Here, etc.

It should be noted that the above implementations of directing the driving direction of the vehicle by the indicator light are only illustrative description of at least one embodiment of the present disclosure. At least one embodiment of the present disclosure neither limit the type of the indicator light, nor limit the indication manners and/or the lighting colors of the indicator light. As long as the indication form of the indicator light may direct the vehicle to enter the target parking space correctly, it may be used to construct the indicator light in at least one embodiment of the present disclosure.

In the above-mentioned embodiment, it is illustrated that the parking space navigation method provided by at least one embodiment of the present disclosure needs to take the current vacancy information of the parking lot into account, when searching for the optimal parking space (i.e., the target parking space) for the vehicle. That is, the method further includes: acquiring the vacancy information of the parking lot in real time. Determining the target parking space needs to be performed based on the current vacancy information. Since there are vehicles that continuously drive in and out in the parking lot, and thus the vacancy information is also constantly changing, it is required to acquire the vacancy information in real time.

Optionally, in at least one embodiment of the present disclosure, after the system acquires the vacancy information of the parking lot in real time, the method may further include: adjusting the target parking space of the vehicle and re-planning the parking route of the vehicle according to the vacancy information acquired in real time. It may be understood that, in one case, after the system determines the target parking space for the specified vehicle, other vehicles may enter the target parking space before the specified vehicle enters the target parking space. In this case, if the vehicle is still driving to this parking space, it cannot park normally. Therefore, after the system knows, according to the vacancy information acquired in real time, that the target parking space determined for some vehicle has been occupied, the system may find a suitable target parking space again for the vehicle, and re-plan a parking route; in another case, the target parking space that the system firstly determines for the specified vehicle is farther away from the vehicle and the route is longer, and other vehicles drive out of their parking spaces during the traveling of the vehicle. At this time, according to the vacancy information acquired in real time, the system may know that there is a more convenient target parking space for the vehicle, that is, the system may adjust the target parking space of the vehicle and re-plan the parking route at any time.

In an implementation of at least one embodiment of the present disclosure, the acquiring the vacancy information of the parking lot in real time may include: capturing an image of each parking space in the parking lot in real time, and acquiring the vacancy information of the parking lot according to the captured image. In at least one embodiment of the present disclosure, the current vacancy information of the parking lot is acquired by using the camera to capture the images of the parking spaces. In actual applications, a plurality of cameras may be arranged in the parking space area for capturing pictures of the parking spaces in real time, and the captured pictures may be compared to pre-stored pictures of vacant parking spaces, so as to analyze if the parking space is vacant. The analysis method may be, for example, analyzing the current picture state of the parking space and the picture of the parking space with no vehicle parked, extracting two sets of features, such as colors and textures of the pictures, and then using an image matching algorithm for detection; when a matching degree is less than a predetermined threshold (for example, the threshold is set to be 30%), the parking space is considered to be occupied; when the matching degree is greater than or equal to the threshold, the parking space is considered to be vacant; and when the entire parking lot has no vacant parking space, the driver is prompted at the entrance of the parking lot that the parking lot is full.

In an implementation of at least one embodiment of the present disclosure, acquiring the vacancy information of the parking lot in real time may include: monitoring the current state of each parking space in real time according to a sensing apparatus in each parking space of the parking lot, and acquiring the vacancy information of the parking lot according to the monitoring result. In at least one embodiment of the present disclosure, the sensing device arranged in each parking space is used to detect the current state of each parking space in real time, so as to acquire the vacancy information of the parking lot. The sensing apparatus may be an infrared monitoring apparatus, or a sensor, etc.

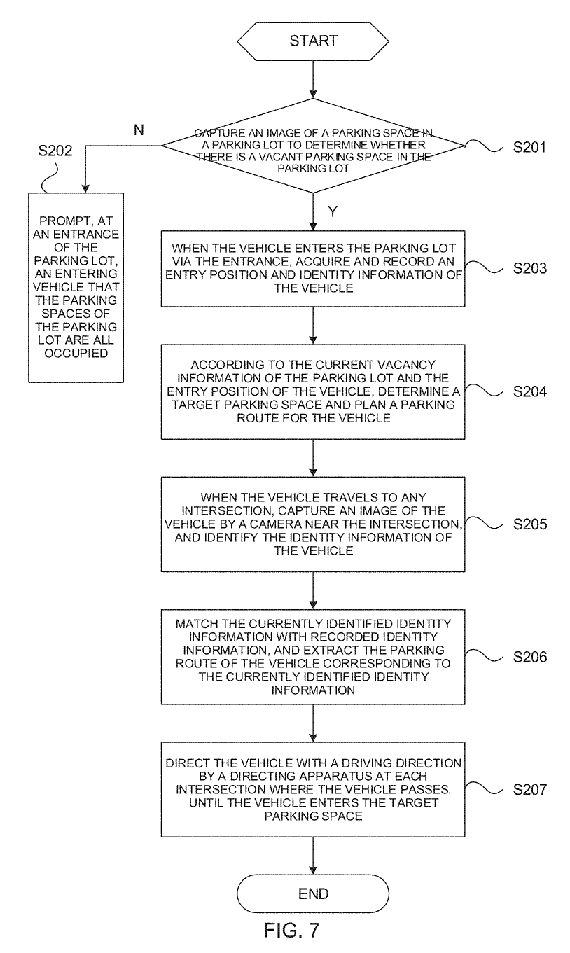

Hereinafter, the parking space navigation method provided by at least one embodiment of the present disclosure will be described in detail in conjunction with an actual application scenario. FIG. 7 is an exemplary flowchart of yet another parking space navigation method according to at least one embodiment of the present disclosure. The method provided by at least one embodiment of the present disclosure includes:

step S201 of capturing an image of a parking space in a parking lot to determine whether there is a vacant parking space in the parking lot; when there is no vacant parking space, proceeding to step S202; when there is a vacant parking space, proceeding to step S203;

step S202 of prompting, at an entrance of the parking lot, an entering vehicle that the parking spaces of the parking lot are all occupied;

step S203 of when the vehicle enters the parking lot from the entrance, acquiring and recording an entry position and identity information of the vehicle, the identity information being used for navigation of the target parking space subsequently;

step S204 of according to the current vacancy information of the parking lot and the entry position of the vehicle, determining a target parking space for the vehicle and planning a parking route for the vehicle;

step S205 of when the vehicle travels to any intersection, capturing an image of the vehicle by a camera near the intersection, and identifying the identity information of the vehicle;

step S206 of matching the currently identified identity information with recorded identity information, and extracting the parking route of the vehicle corresponding to the currently identified identity information;

step S207 of directing a driving direction of the vehicle by an indicator light at each intersection where the vehicle passes, until the vehicle enters the target parking space.

In a case that the vehicle enters the parking lot and the vehicle itself has no network signal, the parking space navigation method provided by at least one embodiment of the present disclosure may realize the parking navigation by completely relying on the parking space navigation system within the parking lot, without any vehicle navigation or mobile navigation APPs, thereby avoiding the demand for GPS signals by the parking navigation and improving reliability of the parking space navigation.

Based on the parking space navigation method provided by the above embodiments of the present disclosure, at least one embodiment of the present disclosure further provides an exemplary parking space navigation system for performing the parking space navigation method provided by any of the above embodiments of the present disclosure.

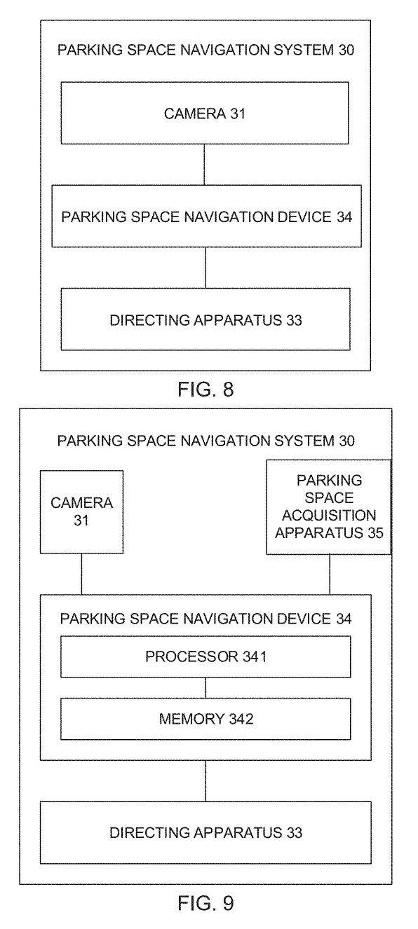

FIG. 8 is an exemplary schematic structure diagram of a parking space navigation system 30 according to at least one embodiment of the present disclosure. The parking space navigation system 30 provided in the present embodiments may include a camera 31, a directing apparatus 33, and a parking space navigation device 34.

The camera 31 is configured to capture an image of a vehicle that enters the parking lot and acquire an entry position and/or identity information of the vehicle. Moreover, as described above, in some other embodiments, the entry position and/or the identity information of the vehicle may also be acquired by other means, such as by electronic license plates, electronic tags, and the like.

The parking space navigation system 30 provided by at least one embodiment of the present disclosure is used to guide the vehicle in the parking lot to be directed to a planned parking space. The camera 31 in at least one embodiment of the present disclosure may include a camera arranged at each entrance in the parking lot. Each camera is used to capture an image of the vehicle entering the parking lot from the current entrance, and collect related information of the vehicle, e.g., including the entry position and the identity information. When the parking route is planned for the vehicle, the entry position of the vehicle may be taken into account to find the optimal parking space for the vehicle, for example, a parking space that makes the vehicle travels the shortest distance, or a parking space closest to the destination address of the vehicle; then, the identity information is used to identify the vehicle when the vehicle is subsequently navigated for parking.

It should be noted that the identity information of the vehicle in at least one embodiment of the present disclosure is information for identifying the vehicle, which may be license plate information of the vehicle, and may also be an electronic license plate or an electronic tag of the vehicle; for example, when some vehicle enters the parking lot, the electronic apparatus at the entrance configures the vehicle with an electronic tag for quickly and accurately identifying the vehicle during subsequent navigation.

The parking space navigation device 34 is configured to receive the image captured in real time from the camera 31, thereby acquiring the entry position and the identity information of the vehicle; determine a target parking space for the vehicle and plan a parking route for the vehicle according to the current vacancy information of the parking lot and the entry position of the vehicle; and control the directing apparatus 33 in the parking lot to direct the vehicle to enter the target parking space according to the identity information and the parking route of the vehicle.

When the parking space navigation device 34 of at least one embodiment of the present disclosure performs a route planning of the parking space for some vehicle, the parking space navigation system 30 first needs to know which of the current parking spaces in the parking lot are not parked, so that the parking space navigation system 30 may know the current vacancy information of the parking lot.

It should be noted that the current vacancy information identified by the parking space navigation system 30 includes not only the currently vacant parking spaces in the parking lot, but also the parking spaces that have been planned for other vehicles although not being occupied by any vehicle. In addition, illustration of the parking space, the vacancy information, the target parking space and the parking route of the parking lot may refer to the illustrative description of FIG. 2 in the above embodiments, and therefore no further details are provided herein.

The directing apparatus 33 is configured to display correspondingly according to the control of the parking space navigation device 34, directing the driving route and direction of the vehicle.

The parking space navigation system 30 of at least one embodiment of the present disclosure may control the directing apparatus 33 in the parking lot to direct some vehicle with the driving route and direction according to the parking route that has been planned for the specified vehicle, until the vehicle is directed to enter the target parking space. In an actual process of directing the parking, since the vehicle is a dynamic object, its position in the parking lot is also dynamically changed according to its driving route. Therefore, in the process of directing the vehicle to enter the target parking space, the vehicle may be directed in combination with the identity information of the vehicle. The identity information of the vehicle is unique information of the vehicle as the vehicle identification when the vehicle enters the entrance of the parking lot. By identifying and distinguishing the vehicle by the identity information, it is ensured that each vehicle is directed to the corresponding target parking space according to the parking route planned for the vehicle.

It should be noted that the parking space navigation system 30 in the embodiments of the present disclosure does not need to hire a staff to clear and guide the traffic conditions in the parking lot, thereby saving labor costs and avoiding safety hazards caused by human operations. Additionally, there is no need to use any vehicle navigation and mobile navigation APPs, so that the parking guidance in the parking lot does not need to rely on the Global Positioning System (GPS), which thus avoids navigation failure due to the poor network signal. When the parking space navigation method in the embodiments of the present disclosure is used for navigating the vehicle entering the parking lot to park, only various facilities configured within the parking lot are relayed on for directing and navigation, the driver may be indicated to accurately enter the planned parking space, and it may also avoid unnecessary disputes caused by multiple drivers in order to compete for one parking space.

In the parking space navigation system provided by the embodiments of the present disclosure, based on the current known vacancy information in the parking lot, the optimal parking space (i.e., the target parking space) may be determined for the vehicle entering the parking lot, and the parking route may be planned for it, and the vehicle may be directed to enter the target parking space based on the acquired identity information, wherein the directing manner may be accurately directed by the indicator light in the parking lot. The parking space navigation method provided by the embodiments of the present disclosure may indicate the driver to enter the planned parking space accurately dependent only on various facilities configured within the parking lot. That is, the parking space navigation method provided by the embodiments of the present disclosure realizes an intelligent navigation in the parking lot without relying on the network navigation and the human guidance, thereby solving the problem that the driver has difficulty in finding the route to the parking space in the parking lot, and enabling efficient and fast parking.

Further, the system may know not only the parking spaces that are currently vacant, but also the parking spaces that have been planned for other vehicles that are not in the parking lot but have not been occupied yet. Therefore, when planning the target parking space for the newly entered vehicle, both the actual occupied parking spaces and the potentially occupied parking spaces may be excluded, thereby avoiding unnecessary disputes caused by multiple drivers in order to compete for one parking space.

Optionally, in at least one embodiment of the present disclosure, indicators that may be shown by the directing apparatus 33 as described above include, for example, Turn Left, Turn Right, Go Forward, U-Turn, Halt and Parking Here, etc. The directing apparatus 33 may be e.g. an indicator light, and the indicator light may be operated in one or more of following modes:

first mode where different colors displayed by the indicator light indicate different driving states of the vehicle;

second mode where different colors displayed by the indicator light indicate different driving directions of the vehicle; and

third mode where different symbols displayed by the indicator light indicate different driving directions of the vehicle.

The implementation of directing the driving direction of the vehicle by different colors and symbols of the LED indicator light (including the Turn-Right arrow, the Turn-Left arrow, and the Go-Forward arrow) has been described in detail in the application scenarios as shown in FIGS. 4 to 6 above, and thus description thereof will be omitted here for simplicity.

Optionally, FIG. 9 is an exemplary schematic structure diagram of another parking space navigation system 30 according to at least one embodiment of the present disclosure. On a basis of the system shown in FIG. 8, in the system 30 provided by at least one embodiment of the present disclosure, the camera 31 is further used for capturing an image of the vehicle in the parking lot in real time and identifying the identity information of the vehicle.

The camera 31 of at least one embodiment of the present disclosure may further include a plurality of cameras arranged at different positions in the parking lot for capturing the images of the vehicles in the parking lot in real time. That is, when the vehicles are traveling at different positions in the parking lot, the camera closer to the vehicle may capture an image of the vehicle and identifies its identity information. At this time, the identified identity information is consistent with the identity information of the vehicle when entering the parking lot.

It should be noted that at least one embodiments of the present disclosure do not limit the manner in which the camera 31 captures the images of the vehicles in the parking lot in real time. For example, it may be performed according to a certain time period, or may be performed when the camera detects a change of the surrounding vehicle.

The parking space navigation device 34 in at least one embodiment of the present disclosure may include a processor 341 and a memory 342. The memory 342 stores instructions that, when executed by the processor 341, cause the processor 341 to:

match the currently identified identity information with the recorded identity information, extract the parking route of the vehicle corresponding to the currently identified identity information; and control the directing apparatus 33 in the parking lot to direct the vehicle to enter the target parking space according to the extracted parking route.

In at least one embodiment of the present disclosure, when some vehicle travels to any position in the parking lot, the camera in a range of the position may capture and identify the identity information of the vehicle as a basis for directing the vehicle to enter the parking space accurately. Each time the identity information of the vehicle is identified, the identity information is compared with the identity information recorded in the parking space navigation system 30, and the parking route that has been planned for the vehicle is extracted, then the indicator light is controlled according to the parking route to navigate the parking of the vehicle.

Optionally, in at least one embodiment of the present disclosure, the implementation of controlling, by the parking space navigation device 34, the directing apparatus 33 in the parking lot to direct the vehicle to enter the target parking space may include: controlling the indicator light in the parking lot to indicate the vehicle at each intersection where the vehicle passes, until the vehicle is directed to enter the target parking space.

In practical applications, since the parking space navigation system 30 indicates the driving route and direction by only the directing apparatus 33 without the network navigation, based on the actual environment and route conditions in the parking lot, the directing apparatus 33 includes indicator lights arranged at different positions of the parking lot, e.g., arranged at the intersection or other crossings, if the vehicle travels in a straight line, and does not encounter an intersection during travelling, it does not need to change the direction, and thus no special guidance is needed at this time. When the vehicle encounters an intersection or other crossings, the direction to which the vehicle is driven is closely related to whether a parking space can be accurately found for the vehicle. Therefore, the vehicle may be specially indicated at each intersection where the vehicle passes, e.g., Turn Left, Turn right, or Go Forward. The vehicle may be directed to the target parking space by the guidance of the indicator lights at one or more intersections. The approach of directing, by the directing apparatus 33, the vehicle at each intersection where the vehicle passes is similar to the illustrative approach described above in the scenario of at least one embodiment of the present disclosure as shown in FIG. 4, and thus description thereof will be omitted here for simplicity.

In practical scenarios, there are usually more than one vehicle looking for the parking space in the parking lot, and there may be a plurality of vehicles at each intersection that need the guidance of the parking route. The plurality of vehicles may be located in different arms of one intersection. Each of the vehicles at different geographical locations may be directed by the indicator light in the vicinity of the vehicle. The driving direction of each of the plurality of vehicles located in different arms of one intersection is required to be directed separately. In this case, the implementation of controlling the indicator lights in the parking lot to direct the vehicle to enter the target parking space in at least one embodiment of the present disclosure may include approaches as follows.

First Approach—

Controlling the indicator lights at the intersection to direct the plurality of vehicles with the respective driving directions sequentially according to priorities of the respective vehicles.

Second Approach—

Controlling the indicator lights at the intersection to direct each of the vehicles with the respective driving direction simultaneously.

The approach of indicating the driving directions of the plurality of vehicles at the intersection by the directing apparatus 33 in at least one embodiment of the present disclosure is similar to the illustrative approach of the scenarios in the above embodiments as shown in FIG. 5 and FIG. 6, and thus description thereof will be omitted here for simplicity.

It should be noted that the above implementations of directing the driving direction of the vehicle by the indicator light are only illustrative description of the embodiments of the present disclosure. The embodiments of the present disclosure neither limit the type of the indicator light, nor limit the indication manners and/or the lighting colors of the indicator light. As long as the indication form of the indicator light may direct the vehicle to enter the target parking space correctly, it may be used to construct the indicator light in the embodiments of the present disclosure.

In the above-mentioned embodiments, it is illustrated that the parking space navigation system 30 provided by at least one embodiment of the present disclosure needs to take the current vacancy information of the parking lot into account, when searching for the optimal parking space (i.e., the target parking space) for the vehicle. That is, the parking space navigation system 30 further includes a parking space acquisition apparatus 35 for acquiring the vacancy information of the parking lot in real time. Determining the target parking space needs to be performed based on the current vacancy information. Since there are vehicles that continuously drive in and out in the parking lot, and thus the vacancy information is also constantly changing, it is required to acquire the vacancy information in real time. In some embodiments, the parking space acquisition apparatus 35 may be one or more cameras, or may be a sensor dedicated to detect the parking state of the parking space.

Optionally, in at least one embodiment of the present disclosure, the parking space navigation device 34 is further configured to, after the parking space acquisition apparatus 35 acquires the vacancy information of the parking lot in real time, adjust the target parking space of the vehicle and re-plan the parking route of the vehicle according to the vacancy information acquired in real time. It may be understood that, in one case, after the parking space navigation device 34 determines the target parking space for the specified vehicle, other vehicles may enter the target parking space before the specified vehicle enters the target parking space. In this case, if the vehicle is still driving to this parking space, it cannot park normally. Therefore, when the parking space navigation device 34 may know, according to the vacancy information acquired in real time by the parking space acquisition apparatus 35, that the target parking space determined for some vehicle has been occupied, the parking space navigation device 34 may find a suitable target parking space again for the vehicle, and re-plan a parking route; in another case, the target parking space that the parking space navigation device 34 firstly determines for the specified vehicle is farther away from the vehicle and the route is longer, and other vehicles drive out of their parking spaces during the traveling of the vehicle. At this time, according to the vacancy information acquired in real time, the parking space navigation device 34 may know that there is a more convenient target parking space for the vehicle, that is, the parking space navigation device 34 may adjust the target parking space of the vehicle and re-plan the parking route at any time.

In an implementation of at least one embodiment of the present disclosure, the parking space acquisition apparatus 35 may include a capturing unit for capturing an image of each parking space in the parking lot in real time, and a parking space acquisition unit for acquiring the vacancy information of the parking lot according to the captured image. In at least one embodiment of the present disclosure, the capturing unit may be cameras arranged near the parking spaces in the parking lot. These cameras may be used for capturing the images of the parking spaces to acquire the current vacancy information of the parking lot. In actual applications, a plurality of cameras may be arranged in the parking space area for capturing pictures of the parking spaces in real time, and the captured pictures may be compared to pre-stored pictures of vacant parking spaces, so as to analyze if the parking space is vacant. The analysis method may be, for example, analyzing the current picture state of the parking space and the picture of the parking space with no vehicle parked, extracting two sets of features, such as colors and textures of the pictures, and then using an image matching algorithm for detection; when a matching degree is less than a predetermined threshold (for example, the threshold is set to be 30%), the parking space is considered to be occupied; when the matching degree is greater than or equal to the threshold, the parking space is considered to be vacant; and when the entire parking lot has no vacant parking space, the driver is prompted at the entrance of the parking lot that the parking lot is full.

In an implementation of at least one embodiment of the present disclosure, the parking space acquisition apparatus 35 may include a monitoring unit for monitoring the current state of each parking space in real time according to a sensing apparatus in each parking space of the parking lot, and a parking space acquisition unit for acquiring the vacancy information of the parking lot according to the monitoring result. In at least one embodiment of the present disclosure, the sensing device arranged in each parking space is used to detect the current state of each parking space in real time, so as to acquire the vacancy information of the parking lot. The sensing apparatus may be an infrared monitoring apparatus, or a sensor, etc.

The embodiments disclosed in the present disclosure are described above, but are merely used to facilitate the understanding of the present disclosure, but not intended to limit the present disclosure. Any modification and variation may be made by the skilled in the art in forms and details of the implementations without departing from the spirit and scope of the present disclosure. The scope of the present disclosure is defined by the appended claims.

1. A parking space navigation method, comprising:
acquiring, by a processor, an entry position and identity information of a vehicle;
determining, by the processor, a target parking space according to current vacancy information of a parking lot and the entry position of the vehicle;
planning, by the processor, a parking route for the vehicle based on the target parking space; and
controlling, by the processor, a directing apparatus in the parking lot according to the identity information of the vehicle and the parking route to direct the vehicle to enter the target parking space.

2. The parking space navigation method according to claim 1, wherein the directing apparatus is an indicator light.

3. The parking space navigation method according to claim 1, further comprising:
identifying, by the processor, the identity information of the vehicle according to a received image of the vehicle in the parking lot which is captured in real time;
the step of controlling the directing apparatus in the parking lot according to the identity information of the vehicle and the parking route to direct the vehicle to enter the target parking space comprises:
matching, by the processor, currently identified identity information with recorded identity information to extract a parking route corresponding to the currently identified identity information; and
controlling, by the processor, the directing apparatus in the parking lot according to the extracted parking route to direct the vehicle to enter the target parking space.

4. The parking space navigation method according to claim 1, wherein the step of controlling, by the processor, the directing apparatus in the parking lot to direct the vehicle to enter the target parking space comprises:
controlling, by the processor, the directing apparatus in the parking lot to direct the vehicle with a driving direction at each intersection where the vehicle passes, until the vehicle is directed to enter the target parking space.

5. The parking space navigation method according to claim 4, wherein in a case that a plurality of vehicles enter the parking lot and the plurality of vehicles are located in different arms of an intersection, the controlling, by the processor, the directing apparatus in the parking lot to direct the vehicle with a driving direction at each intersection where the vehicle passes comprises:
controlling, by the processor, the directing apparatus at the intersection to direct each of the plurality of vehicles with the respective driving direction sequentially according to priorities of the plurality of vehicles; or
controlling, by the processor, the directing apparatus at the intersection to direct each of the plurality of vehicles with the respective driving directions simultaneously.

6. The parking space navigation method according to claim 1, further comprising:
acquiring, by the processor, the vacancy information of the parking lot in real time.

7. The parking space navigation method according to claim 6, wherein the acquiring, by the processor, the vacancy information of the parking lot in real time comprises:
acquiring, by the processor, the vacancy information of the parking lot according to a received image of each parking space in the parking lot which is captured in real time; or
acquiring, by the processor, the vacancy information of the parking lot according to a current state of each parking space which is monitored in real time by and received from a sensing apparatus in each parking space in the parking lot.

8. The parking space navigation method according to claim 6, further comprising:
adjusting, by the processor, the target parking space of the vehicle and re-planning the parking route for the vehicle according to the vacancy information acquired in real time.

9. A parking space navigation device, comprising:
a processor;
a memory storing instructions which, when executed by the processor, cause the processor to:
acquire an entry position and identity information of a vehicle;
determine a target parking space and plan a parking route for the vehicle according to current vacancy information of a parking lot and the entry position of the vehicle;
plan a parking route for the vehicle based on the target parking space; and
control a directing apparatus in the parking lot according to the identity information of the vehicle and the parking route to direct the vehicle to enter the target parking space.

10. The parking space navigation device according to claim 9, wherein the directing apparatus is an indicator light.

11. The parking space navigation device according to claim 9, wherein the instructions which, when executed by the processor, further cause the processor to:
identify the identity information of the vehicle according to a received image of the vehicle in the parking lot which is captured in real time;
match currently identified identity information with recorded identity information to extract a parking route corresponding to the currently identified identity information; and
control the directing apparatus in the parking lot according to the extracted parking route to direct the vehicle to enter the target parking space.

12. The parking space navigation device according to claim 9, wherein the instructions which, when executed by the processor, further cause the processor to:
control the directing apparatus in the parking lot to direct the vehicle with a driving direction at each intersection where the vehicle passes, until the vehicle is directed to enter the target parking space.

13. The parking space navigation device according to claim 12, wherein the instructions which, when executed by the processor, further cause the processor to:
in a case that a plurality of vehicles enter the parking lot, and the plurality of vehicles are located in different arms of an intersection,
control the directing apparatus at the intersection to direct each of the vehicles with the respective driving directions sequentially according to priorities of the plurality of vehicles; or
control the directing apparatus at the intersection to direct the vehicles with the respective driving directions simultaneously.

14. The parking space navigation device according to claim 9, wherein the instructions which, when executed by the processor, further cause the processor to:
acquire the vacancy information of the parking lot in real time.

15. The parking space navigation device according to claim 14, wherein the instructions which, when executed by the processor, further cause the processor to:
acquire the vacancy information of the parking lot according to a received image of each parking space in the parking lot which is captured in real time; or
acquire the vacancy information of the parking lot according to a current status of each parking space which is monitored in real time by and received from a sensing apparatus in each parking space in the parking lot.

16. The parking space navigation device according to claim 14, wherein the instructions which, when executed by the processor, further cause the processor to:
adjust, by the processor, the target parking space of the vehicle and re-plan the parking route for the vehicle according to the vacancy information acquired in real time.

17. The parking space navigation device according to claim 9, wherein indicators of the directing apparatus comprises one of more of: Turn Left, Turn Right, Go Forward, U-Turn, Halt, and Parking Here.

18. The parking space navigation device according to claim 10, wherein the indicator light is operated in one or more of following modes:
a mode where different colors displayed by the indicator light indicate different driving states of the vehicle;
a mode where different colors displayed by the indicator light indicate different driving directions of the vehicle; and
a mode where different symbols displayed by the indicator light indicate different driving directions of the vehicle.

19. The parking space navigation method of claim 1, wherein a non-transitory computer readable storage medium has stored thereon instructions which, when executed by one or more processors, cause the one or more processors to perform the parking space navigation method.

20. A parking space navigation system, comprising:
the parking space navigation device according to claim 9;
one or more cameras communicatively coupled to the parking space navigation device and configured to capture an image of an entered vehicle and/or an image of a parking space in a parking lot, and transmit the captured image to the parking space navigation device; and
one or more directing apparatuses communicatively coupled to the parking space navigation device and configured to display an indication for directing the vehicle under control of the parking space navigation device.
